(19) United States
(12) Patent Application Publication
(10) Pub. No.: US 2017/0344250 A1
(43) Pub. Date: Nov. 30, 2017

(54) NUMERICAL CONTROLLER

(71) Applicant: FANUC CORPORATION, Minamitsuru-gun (JP)

(72) Inventor: YAMATO IWAMURA, Minamitsuru-gun (JP)

(73) Assignee: FANUC CORPORATION, Minamitsuru-gun (JP)

(21) Appl. No.: 15/605,316

(22) Filed: May 25, 2017

(30) Foreign Application Priority Data
May 27, 2016 (JP) 2016-106769

(51) Int. Cl. G06F 3/0488; G06F 3/0484

(52) U.S. Cl. CPC G06F 3/04883; G06F 3/04847; G06F 2203/04808

(57) ABSTRACT

A numerical controller making it possible to manipulate a processing machine just as an operator intends without visually observing a screen is for controlling the machine and is provided with: a touch-type pointing device capable of detecting a plurality of touch manipulations performed at the same time; a manipulation analyzing portion analyzing and extracting a first manipulation which is a touch manipulation by at least one touch and a second manipulation which is a manipulation performed while a touch state by the first manipulation is maintained, from among manipulations detected by the touch-type pointing device; and an operation deciding portion deciding a function to be caused to operate, based on the first manipulation and the second manipulation and giving an instruction to perform the operation.

### BACKGROUND OF THE INVENTION

### 1. Field of the Invention

The present invention relates to a numerical controller, and in particular to a numerical controller making it possible to manipulate a machine by a multi-touch gesture using a touch panel.

### 2. Description of the Related Art

When an operator manually manipulates a processing machine, a hardware console provided on the processing machine or an application corresponding to a console, such as a virtual console configured on a display device provided on the processing machine or a numerical controller for controlling the processing machine is used (Japanese Patent Laid-Open No. 2013-125453).

FIG. 12 shows an example of a hardware console provided on a processing machine. A console 40 shown in FIG. 12 is provided with a manual pulse generator 41 and a manual feed button 42.

When plus rotation or minus rotation of a manual handle 41a is performed, the manual pulse generator 41 outputs a pulse signal according to the turn. The pulse signal is a two-phase pulse for identifying a turning direction. The pulse signal is sent to a processor not shown via a bus not shown to cause a tool to move. The manual feed button 42 is provided with plus direction and minus direction feed buttons for each of X, Y and Z axes. Further, a setting switch 43 is a switch for setting an amount of movement when the manual handle 41a is manipulated by one scale graduation.

On the other hand, in an application corresponding to a console, a virtual console screen corresponding to buttons, switches, lamps and the like of a console is displayed on a screen of a display device. On the screen of the display device where the virtual console is displayed, a touch panel making it possible for an operator to perform input by a touch manipulation is superimposed. By performing a touch manipulation of a key, a switch or the like displayed on the screen, the operator can perform a manual manipulation similar to that in the case of manipulating a hardware console.

In the manipulation using a hardware console or an application corresponding to a console described above, however, the operator is required to, at the time of performing the manipulation, visually check a position of a desired button, switch, handle or the like on the console or the virtual console before performing the manipulation. Therefore, at the time of starting the manipulation, during the manipulation, at the time of changing an axis to be manipulated or the like, the operator has to look away from a machine performing processing, and there is a problem that he or she cannot perform the manipulation checking the machine performing processing. Especially in the case of using an application corresponding to a console, it is necessarily required to perform a manipulation confirming the screen because there is not unevenness on buttons, switches and a handle displayed on the screen, and it is not possible to confirm arrangement of each of the buttons, the switches and the handle only by fingertip sensation.

In the case of using a hardware console, since it is possible to confirm arrangement of buttons, switches and a handle by fingertip sensation, an experienced operator could perform a manipulation to some level even in a state of looking away from the console. In manipulation of a machine, however, a fatal problem may be caused by pressing a wrong button by mistake. Therefore, it is not preferred to perform a manipulation, groping on a console. Further, in the case of preparing a hardware console, there is a problem that physical restrictions occur such as limitation of the area of the console and limitation of the number of buttons, switches and handles arranged in the console. Therefore, it is desired to solve the above problem using an application corresponding to a console in which arrangement and kinds of buttons, keys and handles can be changed by software according to situations.

### SUMMARY OF THE INVENTION

Thus, an object of the present invention is to provide a numerical controller making it possible to manipulate a processing machine just as an operator intends without visually observing a screen.

The numerical controller according to the present invention is for controlling a machine and is provided with: a touch-type pointing device capable of detecting a touch manipulation; a manipulation analyzing portion analyzing and extracting a first manipulation which is a touch manipulation by at least one touch and a second manipulation which is a manipulation performed while a touch state by the first manipulation is maintained, from among manipulations detected by the touch-type pointing device; and an operation deciding portion deciding a function of the machine or a function of the numerical controller to be caused to operate, based on the first manipulation and the second manipulation and giving an instruction to cause the function to operate.

In the numerical controller according to the present invention, the machine is provided with one or more axes; and the operation deciding portion decides an axis to be a manual manipulation target among the axes based on the first manipulation, calculates a movement direction and movement speed of the axis to be the manual manipulation target, based on the second manipulation; and gives an instruction to control the decided axis to be the manual manipulation target with the calculated movement direction and movement speed.

In the numerical controller according to the present invention, the operation deciding portion decides the axis to be the manual manipulation target among the axes, based on the number of touch points by the first manipulation.

In the numerical controller according to the present invention, the second manipulation is a touch manipulation; and the operation deciding portion calculates the movement direction and movement speed of the axis to be the manual manipulation target, based on a position of touch points by the first manipulation and a position of touch points by the second manipulation. In the numerical controller according to the present invention, the second manipulation is a drag manipulation; and the operation deciding portion calculates the movement direction and movement speed of the axis to be the manual manipulation target, based on a position of touch points by the first manipulation and a position of touch points by the second manipulation after a drag.

The numerical controller according to the present invention is capable of switching between an operation mode in which a multi-touch gesture manipulation is accepted and an operation mode in which the multi-touch gesture manipulation is not accepted; and the manipulation analyzing portion analyzes and extracts the first manipulation and the second manipulation among the manipulations detected by the touch-type pointing device only in the operation mode in which the multi-touch gesture manipulation is accepted.

According to the present invention, it becomes possible for an operator to manipulate a machine, confirming motion of the machine without paying attention to a manipulation target button or a screen. Further, it is possible to prevent risk of malfunction by specifying patterns and ranges to be used for manipulations in advance.

### BRIEF DESCRIPTION OF THE DRAWINGS

The above-described and other objects and characteristics of the present invention will be apparent from description of an embodiment below with reference to accompanying drawings shown below:

FIG. 1 is a diagram illustrating an outline of a multi-touch gesture manipulation of the present invention;

FIG. 2 is a diagram showing a display example of a touch panel provided on a numerical controller;

FIG. 3 is a diagram showing manipulation examples in a case where the multi-touch gesture manipulation of the present invention is used to cause auxiliary functions of a processing machine to operate;

FIG. 4 is a schematic flowchart of a process of detecting the multi-touch gesture manipulation to perform an axis movement;

FIG. 5 is a diagram showing manipulation examples in a case where the multi-touch gesture manipulation of the present invention is applied to a manual manipulation of an axis of the processing machine;

FIG. 6 is a schematic flowchart of a process of detecting the multi-touch gesture manipulation to perform an axis movement;

FIG. 7 is a diagram showing an example in which a plurality of second manipulations are performed in the multi-touch gesture manipulation shown in FIG. 5;

FIG. 8 is a diagram showing manipulation examples in a case where the multi-touch gesture manipulation of the present invention is applied to manipulation of a robot hand;

FIG. 9 is a hardware configuration diagram showing main portions of a numerical controller according to one embodiment of the present invention;

FIG. 10 is a schematic functional block diagram of the numerical controller according to the one embodiment of the present invention;

FIG. 11 is a diagram showing other examples of the multi-touch gesture manipulation of the present invention; and

FIG. 12 is a diagram showing an example of a console according to a prior-art technique.

### DETAILED DESCRIPTION OF THE PREFERRED EMBODIMENTS

An embodiment of the present invention will be described with reference to drawings.

A numerical controller of the present invention is provided with a function of analyzing a multi-touch gesture manipulation performed by an operator on a touch-type pointing device such as a touch pad and a touch panel provided on the numerical controller and controlling an axis of a control-target machine based on the manipulation.

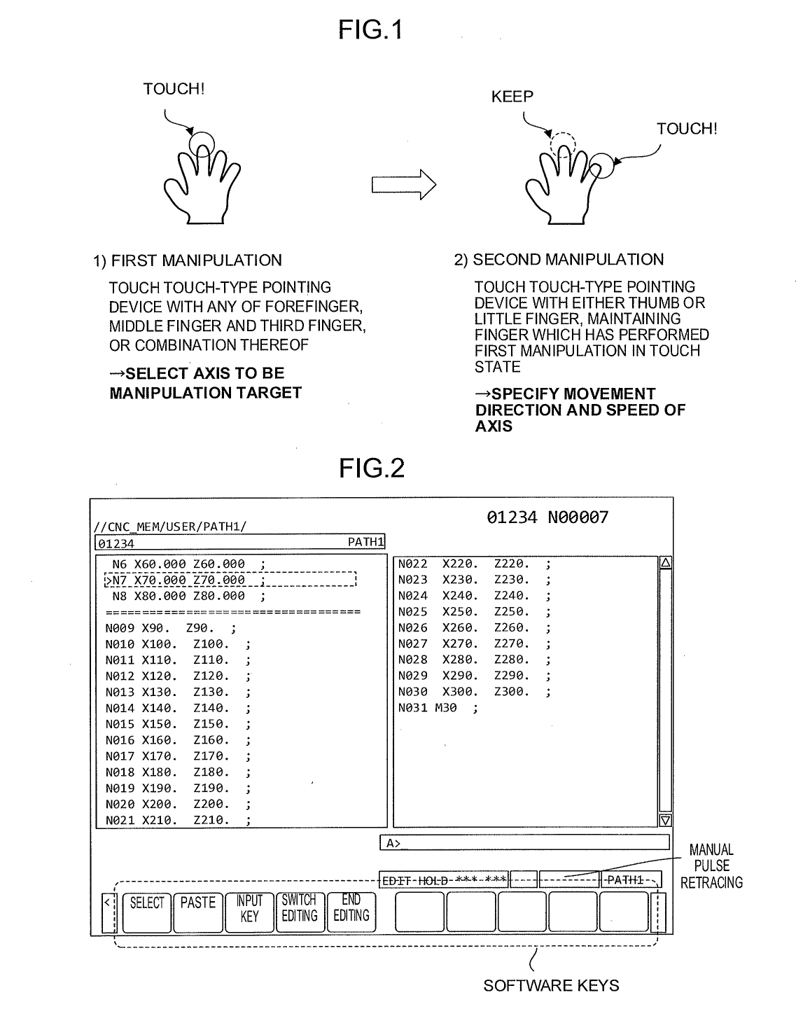

FIG. 1 is a diagram showing an example of a multi-touch gesture manipulation introduced in the present invention. As shown in FIG. 1, in the numerical controller of the present invention, a combination of a first manipulation on the touch-type pointing device and a second manipulation performed while the first manipulation is maintained is detected as a multi-touch gesture manipulation, and an instruction from an operator is analyzed based on the detected multi-touch gesture manipulation. Then, an instructed function is executed based on a result of the analysis. In the example shown in FIG. 1, when a touch manipulation on the touch-type pointing device as the first manipulation is performed by the operator, and an additional touch manipulation on the touch-type pointing device as the second manipulation is performed while the first manipulation is maintained, the series of manipulations is detected as a multi-touch gesture manipulation instructing a manual manipulation of an axis. Then, an axis to be a manual manipulation target is selected based on the number of points touched in the first manipulation, and a movement direction and movement speed of the axis are decided based on a position of a point touched in the second manipulation relative to a position of the points touched in the first manipulation.

For the first and second manipulations, any manipulation may be adopted. Further, any function may be associated with the combination of the first and second manipulations.

When a touch panel is used as the touch-type pointing device which detects a multi-touch gesture manipulation, there may be a case where elements which can be manipulated by a touch manipulation, such as software keys, software buttons and software switches, are displayed on a screen superimposed on the touch panel as shown in FIG. 2. Even in such a case, by adopting appropriate first and second manipulations, it is possible to distinctively detect a manipulation of a software key (a release manipulation immediately after a touch manipulation on an element displayed on the screen) and the multi-touch gesture manipulation introduced in the present invention (the touch manipulation as the first manipulation and the touch manipulation as the second manipulation while the first manipulation is maintained in the example shown in FIG. 1). Of course, it is also possible to provide a dedicated operation mode for accepting multi-touch gesture manipulations so that multi-touch gesture manipulations are accepted only when switching to the operation mode has been performed and are not accepted in a normal operation mode.

As the multi-touch gesture manipulation introduced in the present invention, a manipulation which can be performed with both hands may be adopted. In a multi-touch gesture manipulation which can be performed with both hands, ten fingers of both hands can be used, and complicated manipulations are possible. Therefore, there is an advantage that it is possible to cause a lot of functions to operate. In the case of performing a manipulation with both hands, however, the body direction is limited to a direction toward the touch-type pointing device. Therefore, there is a disadvantage that it becomes difficult to turn eyes toward a machine depending on a positional relationship between the touch-type pointing device and the machine.

In comparison, when a multi-touch gesture manipulation which can be performed with one hand is adopted, only manipulations which can be performed with five or fewer fingers can be performed, but there is an advantage that freedom of orientation of the body increases, and it becomes easier to turn eyes toward a machine.

It becomes possible for the operator who manipulates the numerical controller of the present invention in which such a multi-touch gesture manipulation is introduced to, by performing the first manipulation and the second manipulation in a state of keeping his or her eyes toward a machine, control each of functions of the numerical controller and each function of a machine controlled by the numerical controller without steadily gazing a touch-type pointing device used for manipulation.

Description will be made below by showing actual manipulation examples.

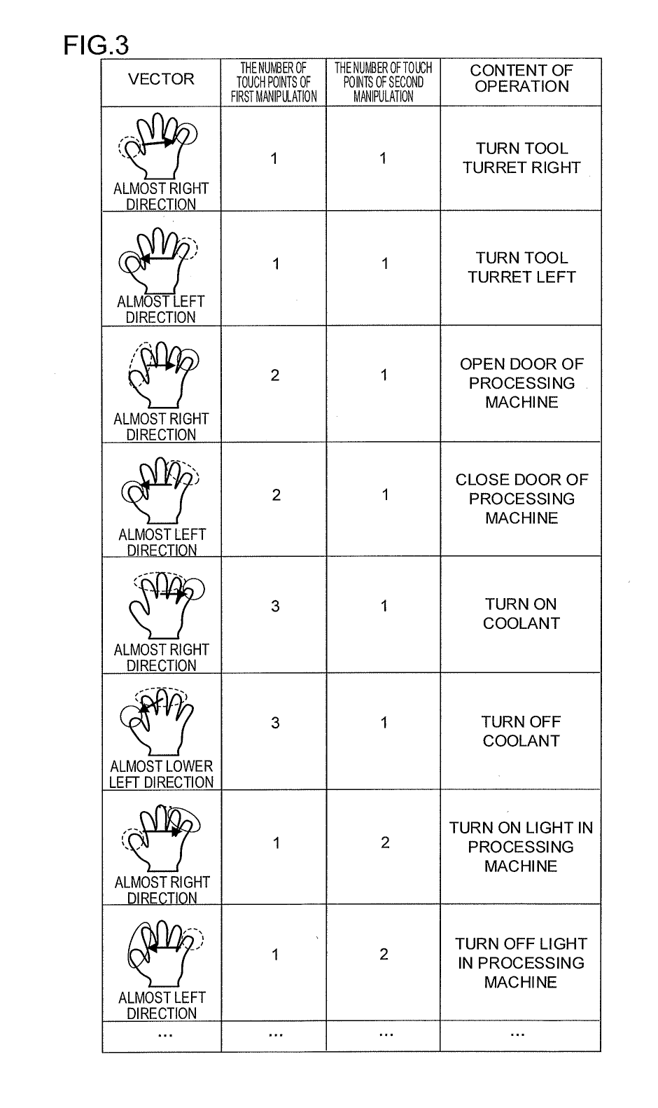

FIG. 3 shows manipulation examples in a case where the multi-touch gesture manipulation of the present invention is used to cause auxiliary functions of a machine controlled by the numerical controller to operate. In the manipulation examples shown in FIG. 3, a function which the operator attempts to cause to operate is identified based on the number of touch points in a first manipulation, the number of touch points in a second manipulation, and a direction and distance (vector) to a touch point position in the second manipulation seen from a touch point position in the first manipulation. For example, in the case of desiring to causing a coolant ON function to operate, the operator performs a three-point touch manipulation with three fingers (the forefinger, the middle finger and the third finger in FIG. 3) on the touch-type pointing device in a first manipulation. Then, in a state of maintaining the touch, he or she additionally performs a one-point touch manipulation in a right direction near a position where the three-point touch has been performed, with one finger (the little finger in FIG. 3) as a second manipulation.

At the time of, when the touch-type pointing device is touched with a plurality of fingers in first and second manipulations, calculating a direction and distance (vector) to a position of touch points in the second manipulation seen from a position of touch points in the first manipulation, an intermediate position (average position) of the plurality of touch points by the plurality of fingers may be treated as a touch point position in each manipulation, or a touch point which is the closest to the position of the touch points by the second manipulation (the first manipulation) among the plurality of touch points by the first manipulation (the second manipulation) may be treated as a touch position of the first manipulation (the second manipulation).

Further, the direction and distance (vector) to the touch point position of the second manipulation when seen from the touch point position of the first manipulation may be different for each operator (for example, because of difference among operators' hands) even if the same manipulation is performed. Therefore, it is recommended that a calibration value (an adjustment value) for the direction and distance (vector) to the touch point position in the second manipulation when seen from the touch point position of the first manipulation in each multi-touch gesture manipulation can be registered by the operator performing a multi-touch gesture manipulation associated with each function on a setting screen in advance. By judging that a multi-touch gesture manipulation has been performed when an error between a calibration value registered as described above and the direction and distance (vector) to the touch point position of the second manipulation when seen from the touch point position of the first manipulation in actual manipulation is within a predetermined range, it is possible to reduce false detection of a multi-touch gesture manipulation.

Furthermore, the size (width) of the operator's hand may be simultaneously set as a threshold in advance so that, when the distance (vector length) between the touch point position of the first manipulation and the touch point position of the second manipulation is larger than a threshold set in advance, a judgment of false detection is made. By doing so, it becomes possible to reduce false detection which may be caused by a chip or cutting fluid coming into contact with the touch-type pointing device, for example.

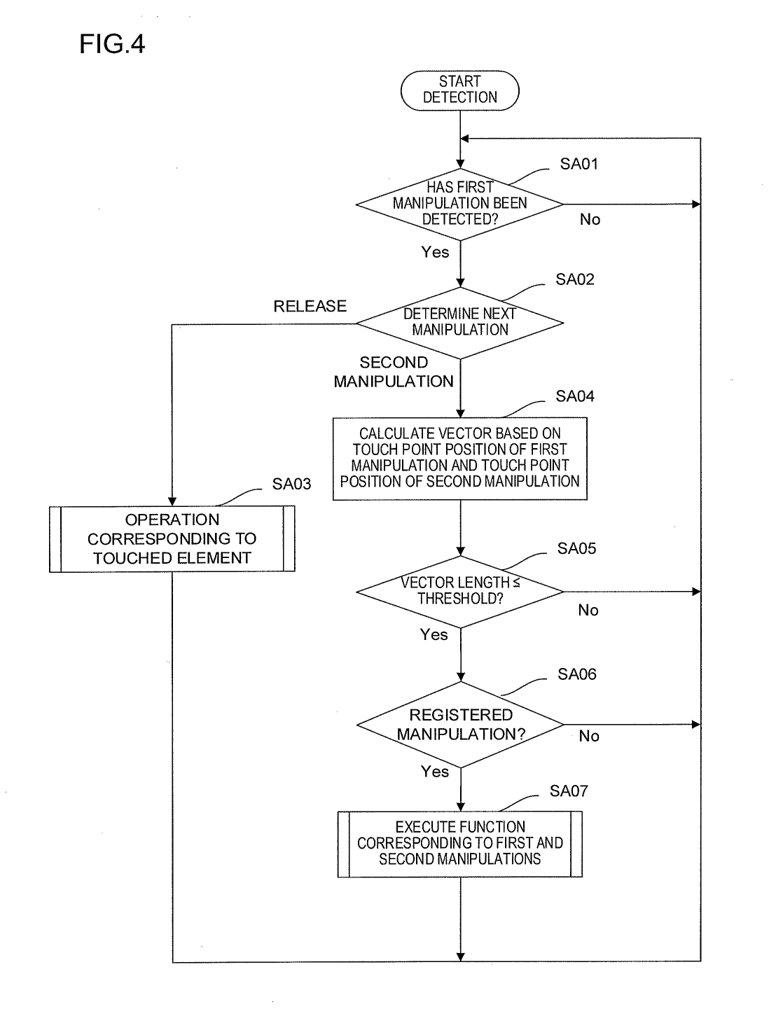

FIG. 4 is a schematic flowchart of the above-described process of detecting a multi-touch gesture manipulation on the touch-type pointing device and causing the auxiliary functions of a control-target machine to operate. The flowchart of FIG. 4 is a flowchart of the process in the case where a touch panel is used as the touch-type pointing device, and software keys and the like are displayed on a screen superimposed on the touch panel.

[Step SA01] The numerical controller determines whether a first manipulation on the touch panel has been detected or not. If the first manipulation on the touch panel (a touch on the touch panel) has been detected, the numerical controller causes the process to proceed to step SA02 and, if not, continues the detection operation.
[Step SA02] The numerical controller detects the next manipulation following the first manipulation detected at step SA01 and determines the kind of the detected manipulation. If the kind of the detected manipulation is second manipulation (a manipulation of releasing a finger which has touched the touch panel in the first manipulation), the numerical controller causes the process to proceed to step SA04. If the kind of the detected manipulation is a manipulation of releasing the finger from the touch panel (release), the numerical controller causes the process to proceed to step SA03.
[Step SA03] The numerical controller starts an operation corresponding to an element displayed at a touch point position in the first manipulation on the touch panel detected at step SA01, among elements (software keys, software buttons, software switches and the like) displayed on the screen superimposed on the touch panel and causes the process to proceed to step SA01.
[Step SA04] The numerical controller calculates the direction and distance to a touch position of the second manipulation detected at step SA02 when seen from a touch position of the first manipulation detected at step SA01, as a vector.
[Step SA05] The numerical controller determines whether or not the vector length of the vector calculated at step SA04 is equal to or smaller than a threshold set in advance (for example, a threshold set in advance based on the size of the operator's hand). If the vector length is equal to or smaller than the threshold, the numerical controller causes the process to proceed to step SA06. If the vector length is above the threshold, the numerical controller makes a judgment of false detection and causes the process to proceed to step SA01 without doing anything.
[Step SA06] The numerical controller determines whether or not the number of touch points of the first manipulation detected at step SA01, the number of touch points of the second manipulation detected at step SA02 and the vector length of the vector calculated at step SA04 are included in registered manipulation patterns of multi-touch gesture manipulations. If they are registered, the numerical controller causes the process to step SA07. If not, the numerical controller determines that the manipulation is not registered and causes the process to proceed to step SA01 without doing anything.
[Step SA07] The numerical controller executes a function decided based on the number of touch points of the first manipulation detected at step SA01, the number of touch points of the second manipulation detected at step SA02 and the vector calculated at step SA04 and causes the process to proceed to step SA01.

Thus, by associating a plurality of functions with a plurality of multi-touch gesture manipulations, it becomes possible for the operator to cause functions of the numerical controller and a machine to operate in a state of steadily gazing the machine.

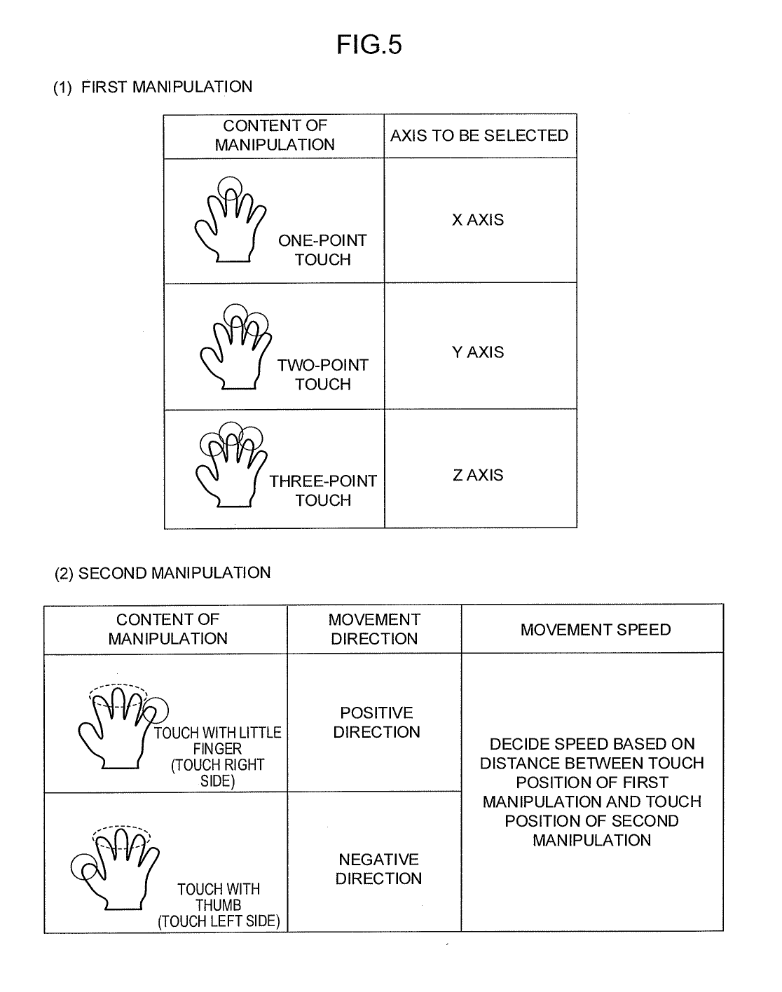

FIG. 5 shows manipulation examples in a case where the multi-touch gesture manipulation of the present invention is applied to a manual manipulation of axes of a machine controlled by the numerical controller. In the manipulation examples, an axis to be selected as a manual manipulation target is decided by a first manipulation, and a movement direction of the selected axis and a movement speed of the selected axis are decided by a second manipulation as illustrated in FIG. 1.

Selection of an axis to be a manual manipulation target in the manipulation examples is decided based on the number of touch points by the first manipulation as shown in FIG. 5. In the examples shown in FIG. 5, an X axis, a Y axis and a Z axis are selected as a manual manipulation target when a one-point touch, a two-point touch and a three-point touch are performed in the first manipulation, respectively. In FIG. 5, the one-point touch is performed with the middle finger, and the two-point touch is performed with the middle finger and the third finger. However, the one-point touch may be performed with the forefinger or the third finger, and the two-point touch may be performed with the forefinger and the middle finger or with the forefinger and the third finger. Furthermore, the thumb, the little finger or a finger of the other hand may be used for the first manipulation if the operator can perform a desired second manipulation.

The movement direction and the movement speed of an axis selected by the first manipulation in the manipulation examples are specified based on a direction and distance (vector) to a touch point position of the second manipulation when seen from a touch point position of the first manipulation as shown in FIG. 5. In the examples shown in FIG. 5, the movement direction of the selected axis is assumed to be a positive direction if the direction of the touch position of the second manipulation when seen from the touch position of the first manipulation is a right-side direction relative to the touch-type pointing device, and the movement direction of the selected axis is assumed to be a negative direction if the direction is a left-side direction relative to the touch-type pointing device. Further, the movement speed of the selected axis can be, for example, a value obtained by multiplying the distance between the touch point position of the first manipulation and the touch point position of the second manipulation by a predetermined coefficient. It is also possible to set a low speed as the speed of the axis starting to move irrespective of the distance between the two points and gradually accelerate the speed so that a speed based on the distance between the two points is obtained. In a case where the touch-type pointing device is touched with a plurality of fingers in the first manipulation, an intermediate position (an average position) among a plurality of touch points by the first manipulation may be treated as the touch point position of the first manipulation. Otherwise, a touch point closest to the position of the touch point by the second manipulation, among the plurality of touch points by the first manipulation, may be treated as the touch position of the first manipulation.

In the manipulation examples, it is also possible to, when the distance (vector length) between the touch point position of the first manipulation and the touch point position of the second manipulation is larger than a predetermined threshold set in advance, make a judgment of false detection. In this case, for example, a threshold may be set based on the size (width) of the operator's hand in advance so that, when the distance between the touch point position of the first manipulation and the touch point position of the second manipulation is larger than the threshold, a judgment of false detection is made.

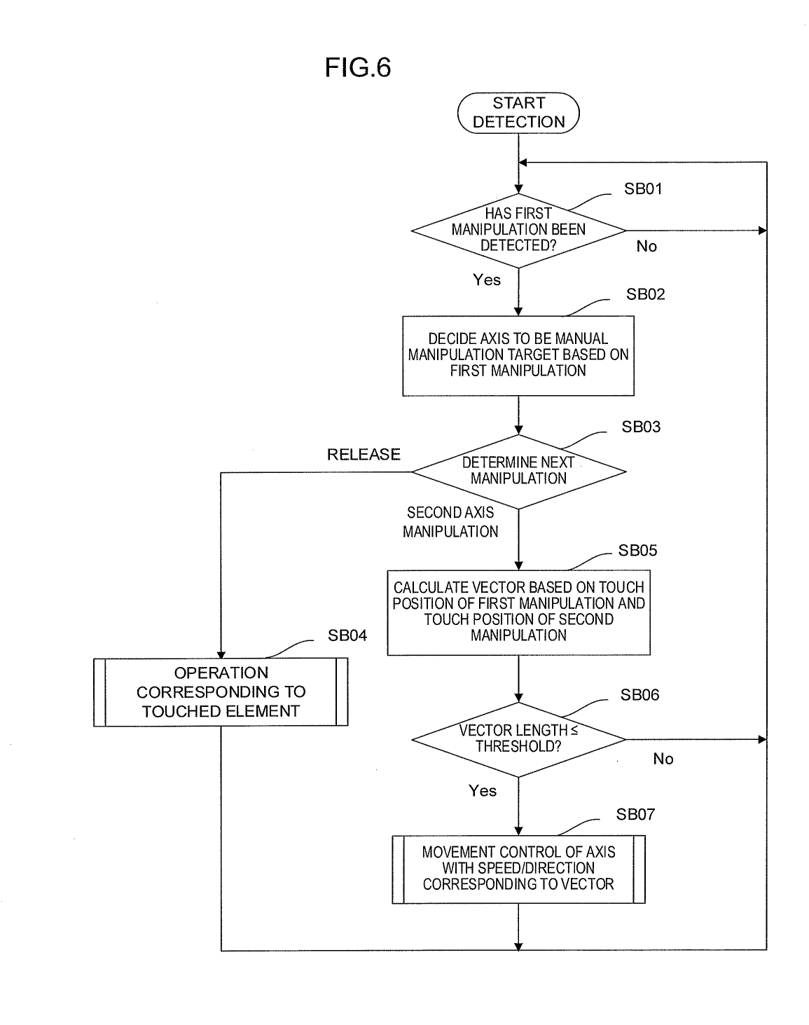

FIG. 6 is a schematic flowchart of the above-described process of detecting a multi-touch gesture manipulation on the touch-type pointing device to perform an axis movement. The flowchart of FIG. 6 is a flowchart of the process in the case where a touch panel is used as the touch-type pointing device, and software keys and the like are displayed on a screen superimposed on the touch panel.

[Step SB01] The numerical controller determines whether a first manipulation on the touch panel has been detected or not. If the first manipulation on the touch panel (a touch on the touch panel) has been detected, the numerical controller causes the process to proceed to step SB02 and, if not, continues the detection operation.
[Step SB02] The numerical controller decides an axis to be a manual manipulation target based on the first manipulation detected at step SB01.
[Step SB03] The numerical controller detects the next manipulation following the first manipulation detected at step SB01 and determines the kind of the detected manipulation. If the kind of the detected manipulation is second manipulation, the numerical controller causes the process to proceed to step SB05. If the kind of the detected manipulation is a manipulation of releasing the finger from the touch panel (release), the numerical controller causes the process to proceed to step SB04.
[Step SB04] The numerical controller starts an operation corresponding to an element displayed at a touch point position in the first manipulation on the touch panel detected at step SB01, among elements (software keys, software buttons, software switches and the like) displayed on the screen superimposed on the touch panel and causes the process to proceed to step SB01.
[Step SB05] The numerical controller calculates the direction and distance to a touch position of the second manipulation detected at step SB03 when seen from a touch position of the first manipulation detected at step SB01, as a vector.
[Step SB06] The numerical controller determines whether or not the vector length of the vector calculated at step SB05 is equal to or smaller than a threshold set in advance (for example, a threshold set in advance based on the size of the operator's hand). If the vector length is equal to or smaller than the threshold, the numerical controller causes the process to proceed to step SB07. If the vector length is above the threshold, the numerical controller makes a judgment of false detection and causes the process to proceed to step SB01 without doing anything.
[Step SB07] The numerical controller performs movement control of the axis to be a manual manipulation target, which has been decided at step SB02, with the movement direction and movement speed decided based on the vector calculated at step SB05.

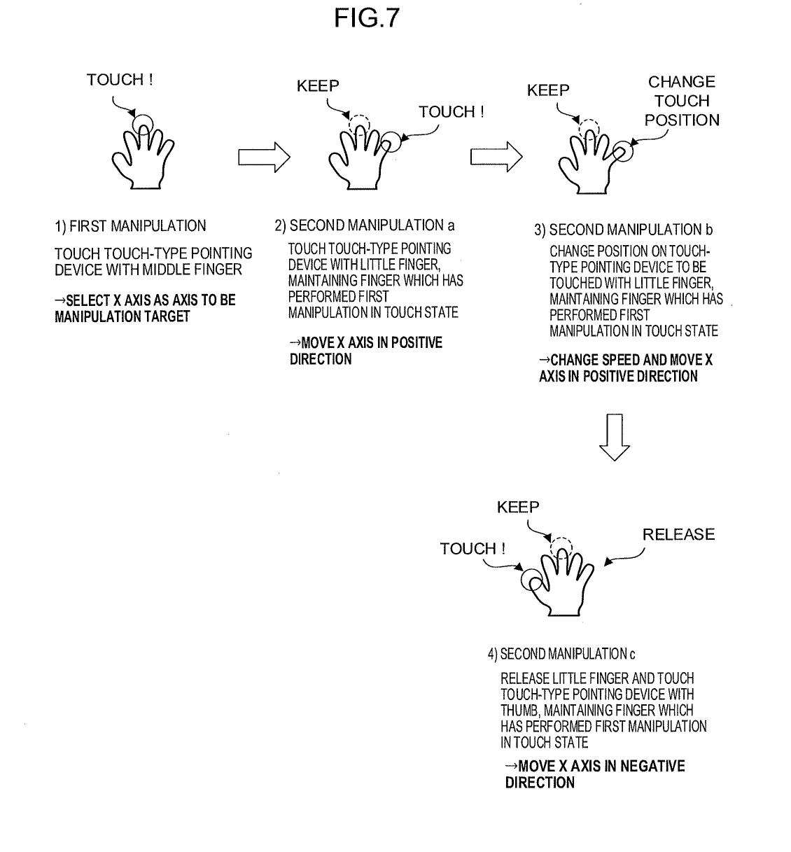

In this manipulation example, it is also possible to, by continuously performing the second manipulation, while the finger touching the touch-type pointing device by the first manipulation are maintained (kept) in a state of being put on the touch-type pointing device, perform a fine axis movement. For example, as shown in FIG. 7, it is assumed that, by touching the touch-type pointing device with the middle finger in a first manipulation and touching the touch-type pointing device with the little finger in a second manipulation a in a state of the X axis being selected as an axis to be a manual manipulation target, the X axis is caused to move in the positive direction. After that, by changing a position of touching the touch-type pointing device with the little finger while maintaining (keeping) the touch by the middle finger in a next second manipulation b, it is possible to cause the X axis in the positive direction with a changed movement speed. Furthermore, by releasing the little finger from the touch-type pointing device by a next second manipulation c (release) and touching the touch-type pointing device with the thumb while maintaining (keeping) the touch by the middle finger, it is also possible to cause the X axis to move in the negative direction. Such a process can be realized by, for example, in the flowchart of FIG. 6, repeating the processes of detection of touch/release manipulations by another finger, vector calculation and axis movement control (a partial process of step SB03 and the processes of steps SB05 to SB07) while the finger which has touched the touch-type pointing device in the first manipulation is maintained in a state of being put on the touch-type pointing device.

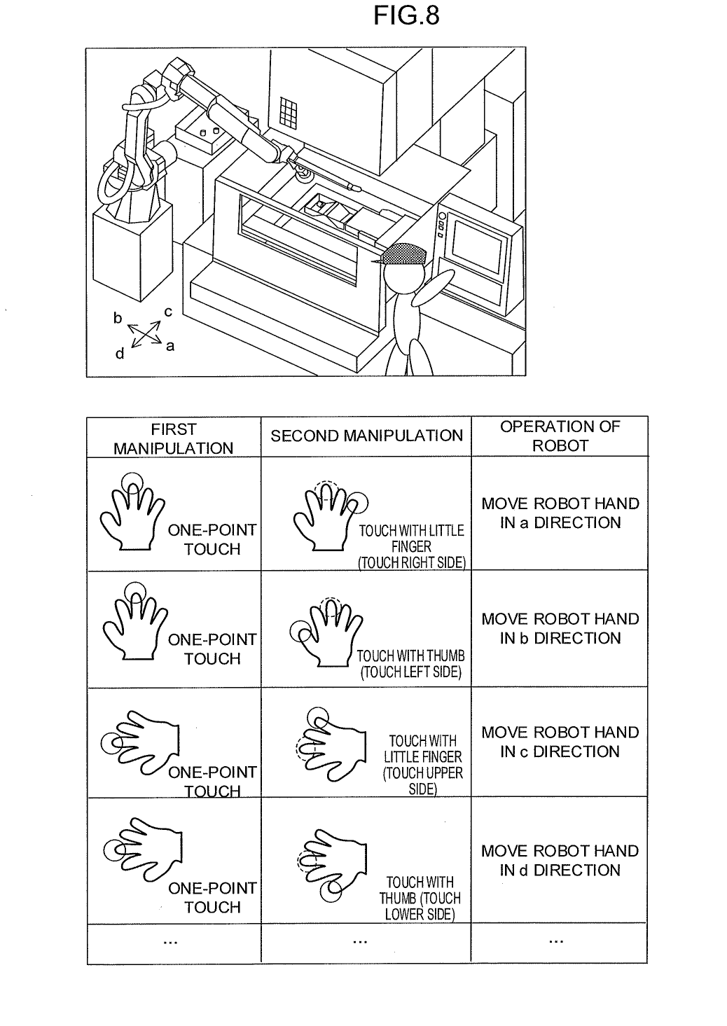

FIG. 8 shows manipulation examples in a case where the multi-touch gesture manipulation of the present invention is applied to manual manipulation of a robot hand. In the manipulation examples, a movement direction and movement speed of the robot hand is decided based on a direction and distance (vector) to a touch point position of a second manipulation when seen from a touch point position of a first manipulation so that a manual manipulation of the robot hand can be performed. In addition, by making it possible to cause the robot hand to move in a vertical direction according to the number of touch points of the first manipulation, it is possible to perform complicated manipulations of the robot hand.

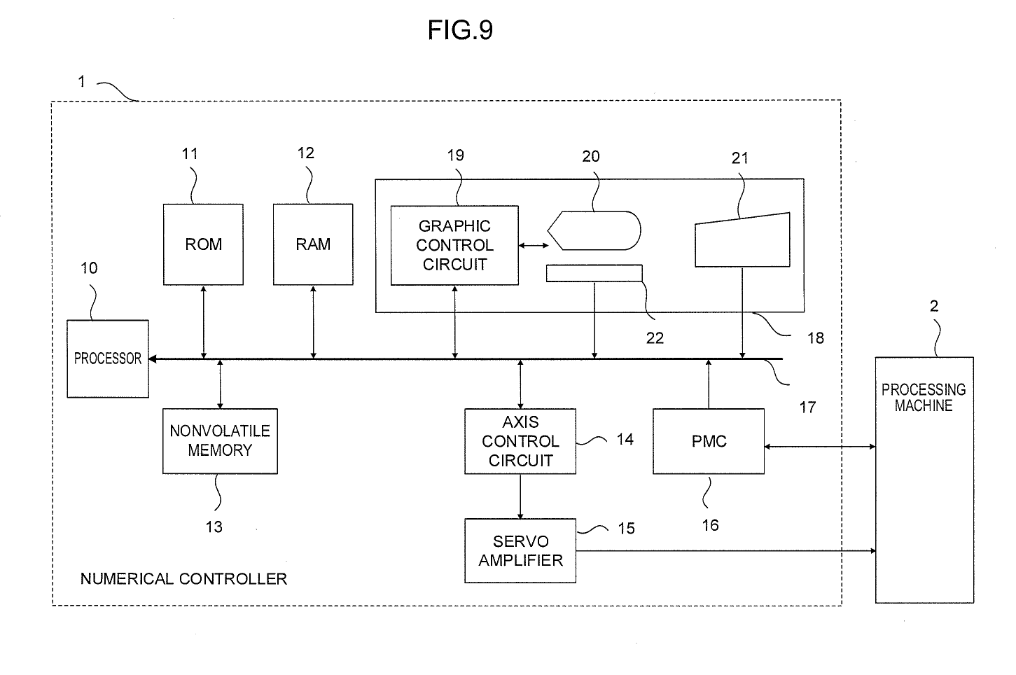

FIG. 9 is a hardware configuration diagram showing main portions of a numerical controller according to one embodiment of the present invention. A numerical controller 1 is configured with a processor as a center. The processor 10 controls the whole numerical controller 1 in accordance with a system program stored in a ROM 11. As the ROM 11, an EPROM or an EEPROM is used.

A DRAM or the like is used as a RAM 12, and temporary calculation data, display data, input/output signals and the like are stored in the RAM 12. A CMOS or an SRAM backed up by a battery not shown is used as a nonvolatile memory 13, and parameters, a processing program, tool correction data and the like which should be held after power is turned off are stored in the nonvolatile memory 13.

An LCD/MDI unit 18 is arranged at the front of the numerical controller 1 or at the same position as a machine console and is used to display data and figures, input data and operate the numerical controller 1.

A graphic control circuit 19 converts a digital signal of numerical data, figure data or the like to a raster signal for display and sends the raster signal to a display device 20. The display device 20 displays the numerical values and figures. A liquid crystal display device is commonly used as the display device 20.

A keyboard 21 is configured with numeric value keys, symbolic keys, character keys and function keys and is used to create and edit a processing program and to operate the numerical controller 1.

A touch-type pointing device 22 is provided with a function of detecting manipulations such as touching and dragging by an operator. In the case of implementing the touch-type pointing device 22 as a touch panel, the touch-type pointing device 22 is arranged being superimposed on the screen of the display device 20. A manipulation performed by the operator on software keys, software buttons and software switches displayed on the screen of the display device 20 can be detected by the touch-type pointing device 22. Information about the manipulation detected by the touch-type pointing device 22 includes information about the kind of the manipulation, such as touching, releasing and dragging, by a plurality of manipulation subjects (such as fingers and a touch pen) on the touch-type pointing device 22, information about values of coordinates where the manipulation has been performed, information about a time required for the manipulation and the like. As the touch-type pointing device 22, a touch panel with any detection system may be used if it is possible to detect simultaneous manipulations (multi-touch) by a plurality of fingers. At the time of detecting a multi-touch manipulation, the touch-type pointing device 22 detects the multi-touch manipulation on the assumption that a touch manipulation performed on the touch-type pointing device 22 within a predetermined threshold specified in advance after a first touch manipulation is performed is regarded as having been performed at the same time as the first touch manipulation. When the touch-type pointing device 22 is a touch panel, the touch panel and the display device 20 may be configured as one device.

Receives an axis movement instruction from the processor 10, an axis control circuit 14 outputs the axis movement instruction to a servo amplifier 15. The servo amplifier 15 amplifies the movement instruction, drives a servo motor combined with a processing machine 2 and controls a relative motion between a tool of the processing machine 2 and a work. Though the axis control circuit 14 and the servo amplifier 15 corresponding to one axis are shown in FIG. 9, the number of axis control circuits 14 and servo amplifiers 15 corresponding to the number of axes of the servo motor are provided.

A PMC (programmable machine controller) 16 receives an M (auxiliary) function signal, an S (spindle speed control) function signal, a T (tool selection) function signal and the like from the processor 10 via a bus 17. Then, the PMC 16 processes the signals with a sequence program and outputs output signals to control pneumatic equipment, hydraulic equipment, an electromagnetic actuator and the like in the processing machine 2. Further, the PMC 16 performs sequence processing in response to various kinds of signals such as a button signal, a switch signal and the like of a machine console in the processing machine 2 and transfers necessary input signals to the processor 10 via the bus 17.

In FIG. 9, a spindle motor control circuit, a spindle motor amplifier and the like are omitted.

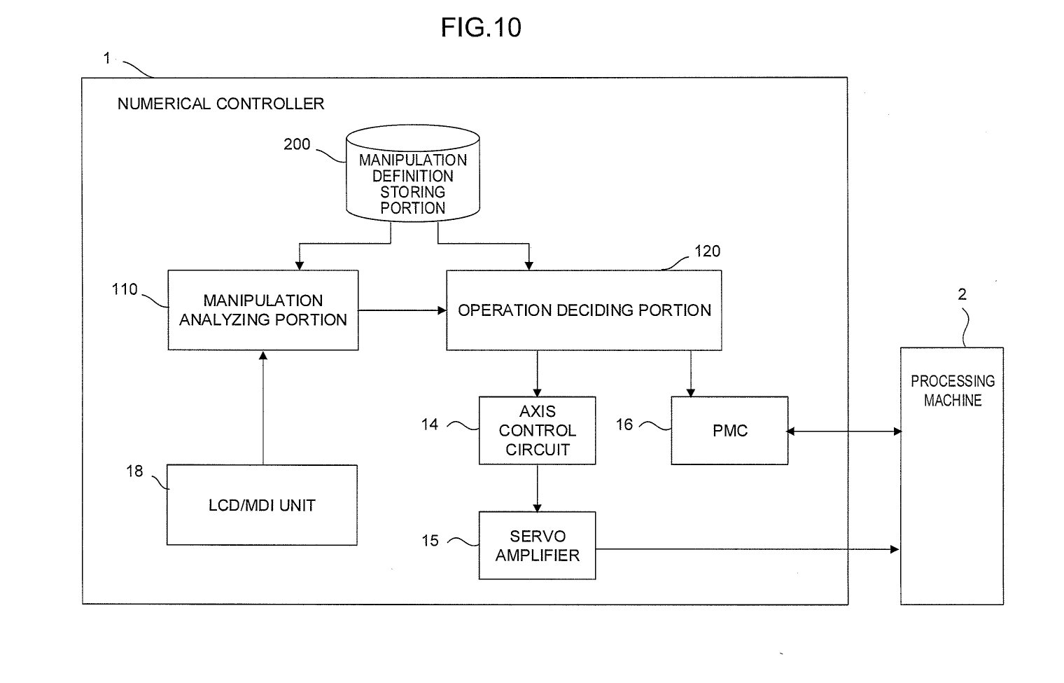

FIG. 10 shows a schematic functional block diagram in a case where a manual axis manipulation function by the multi-touch gesture manipulation of the present invention is implemented in the numerical controller 1 shown in FIG. 9 as a system program. Each functional means shown in FIG. 10 is realized by the processor 10 shown in FIG. 9 executing the system program and providing each function. The numerical controller 1 of the present embodiment is provided with a manipulation analyzing portion 110 and an operation deciding portion 120. Further, the numerical controller 1 of the present embodiment is provided with a manipulation definition storing portion 200 which is a storage area provided on a memory not shown. In the manipulation definition storing portion 200, correspondence relationships between information about manipulation definitions of the multi-touch gesture manipulations (the first manipulations and second manipulations) shown in FIGS. 3 and 5 and the like, and information about the multi-touch gesture manipulations and functions caused to operate by the multi-touch gesture manipulations, calibration settings for each multi-touch gesture manipulation, the size of the operator's hand and the like are set and stored in advance.

The manipulation analyzing portion 110 acquires a manipulation detected by the touch-type pointing device 22 of the LCD/MDI unit 18, analyzes whether the acquired manipulation corresponds to a first manipulation, corresponds to a second manipulation or is another manipulation, and the like, and gives an instruction to the operation deciding portion 120 to be described later or other operating portions not shown (operating portions configured to perform the processes of step SA03 in the flowchart of FIG. 4 or step SB04 in the flowchart of FIG. 6) based on a result of the analysis. More specifically, when a manipulation corresponding to a first manipulation set and stored in the manipulation definition storing portion 200 in advance is performed, the manipulation analyzing portion 110 determines that the manipulation corresponds to a first manipulation; and, when a manipulation corresponding to a second manipulation set and stored in the manipulation definition storing portion 200 in advance is performed in a state of the first manipulation being performed, the manipulation analyzing portion 110 determines that the manipulation corresponds to a second manipulation. Furthermore, when it is judged that the manipulation by the operator corresponds to a second manipulation, a direction and distance (vector) to a touch point position of the second manipulation when seen from a touch point position of the first manipulation is calculated.

Then, when judging that the touch-type pointing device 22 has detected a multi-touch gesture manipulation (a series of a first manipulation and a second manipulation) set in the manipulation definition storing portion 200 in advance, the manipulation analyzing portion 110 instructs the operation deciding portion 120 to perform an operation corresponding to the detected multi-touch gesture manipulation. The manipulation analyzing portion 110 performs the multi-touch gesture manipulation detection judgment by comparing information about the first manipulation, information about the second manipulation, and information about the direction and distance (vector) to the touch point position of the second manipulation when seen from the touch point position of the first manipulation with the information about the manipulation definitions of the multi-touch gesture manipulations (the first manipulations and the second manipulations) registered with the manipulation definition storing portion 200, the information about the calibration settings of each multi-touch gesture manipulation, the size of the operator's hand and the like. When judging that the manipulation detected by the touch-type pointing device 22 does not correspond to any of the multi-touch gesture manipulations set in the manipulation definition storing portion 200 in advance, the manipulation analyzing portion 110 instructs another operating portion decided based on information about the kind of the manipulation detected by the touch-type pointing device 22 and information about values of coordinates where the manipulation has been performed to perform an operation based on the manipulation.

When receiving the instruction from the manipulation analyzing portion 110, the operation deciding portion 120 refers to the manipulation definition storing portion 200 to cause a function corresponding to the multi-touch gesture manipulation detected by the touch-type pointing device 22 to operate. The operation deciding portion 120 determines arguments and parameters (an axis number of a control target axis, a movement direction and movement speed of the axis, and the like) required at the time of causing the function to operate, from the information about the first manipulation analyzed by the manipulation analyzing portion 110 (the number and positions of touch points, and the like), the information about the second manipulation (the number and positions of touch points, and the like) and the information about the direction and distance (vector) to the touch point position of the second manipulation when seen from the touch point position of the first manipulation as necessary, and causes the function corresponding to the multi-touch gesture manipulation to operate using the determined arguments and parameters.

For example, when the multi-touch gesture manipulations shown in FIG. 3 are stored in the manipulation definition storing portion 200, the operation deciding portion 120 identifies, based on the information about the first manipulation, the information about the second manipulation, and the information about the direction and distance to the touch point position of the second manipulation when seen from the touch point position of the first manipulation, a function corresponding to a multi-touch gesture manipulation instructed by these manipulations, and causes the identified function to operate (for example, output a signal to the PMC 16 to open or close the door of the processing machine).

Further, for example, when the multi-touch gesture manipulations shown in FIG. 5 are stored in the manipulation definition storing portion 200, the operation deciding portion 120 decides an axis number of an axis to be a manual manipulation target based on the information about the first manipulation (the number of touch points), and calculates a movement direction and movement speed of the axis to be a manual manipulation target based on the information about the direction and distance (vector) to the touch point position of the second manipulation when seen from the touch point position of the first manipulation. Then, based on the decided axis number and the calculated movement direction and movement speed, the operation deciding portion 120 instructs the axis control circuit 14 to control the axis of the processing machine.

When the first manipulation by the operator ends (such as a case where the manipulation subject that has performed the first manipulation leaves the touch-type pointing device 22) or when the second manipulation ends (such as a case where the manipulation subject that has performed the second manipulation leaves the touch-type pointing device 22), the operation deciding portion 120 gives an instruction to end the operated function, as necessary. For example, as for functions that immediately operate and end when instructed, such as opening/closing of the door of the processing machine and turning on/off of a coolant, it is not necessary to give the end instruction when the first and second manipulations ends. As for functions that continuously operate like a manual manipulation of an axis, however, the operation is caused to end when the first and second manipulations end.

Description has been made on the embodiment of the present invention. The present invention, however, is not limited only to the example of the embodiment described above but can be embodied in various aspects by making appropriate changes.

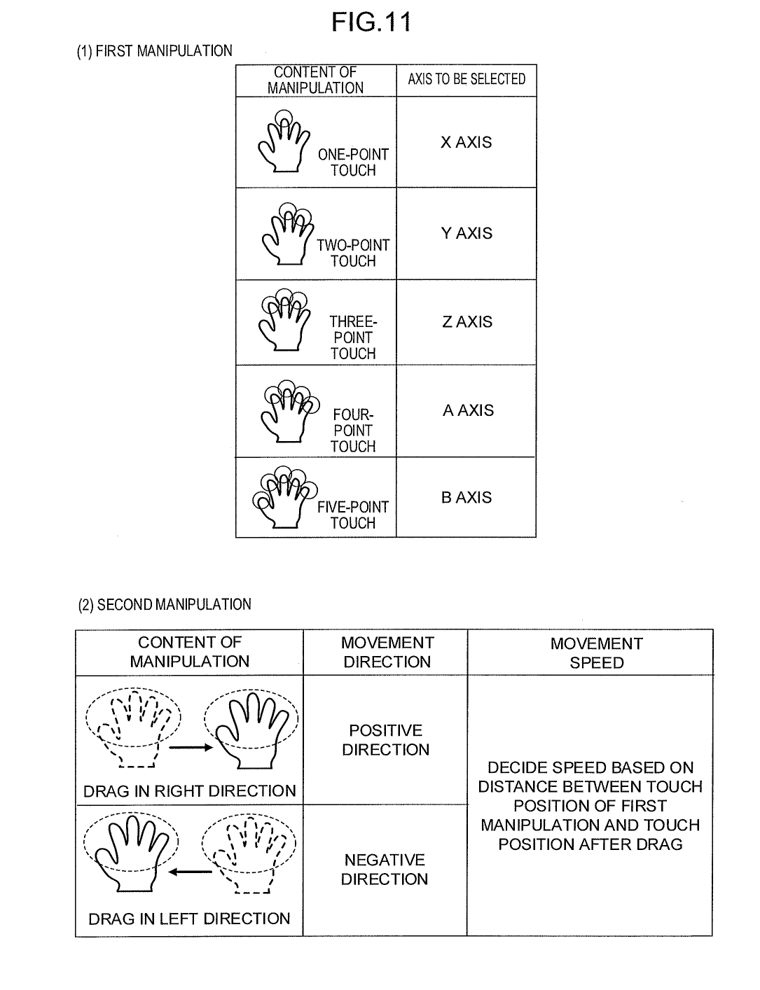

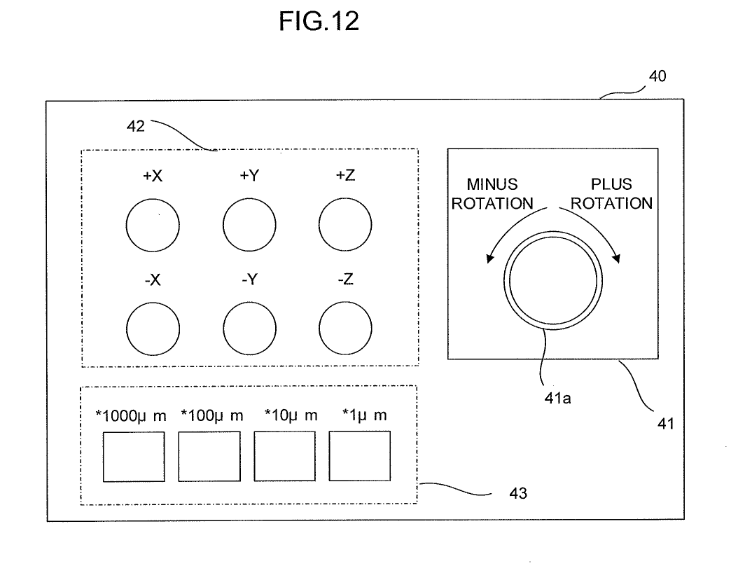

For example, though the multi-touch gesture manipulation described above is such that first and second manipulations are touch manipulations, for example, it is also possible to, instead of the manipulation examples shown in FIG. 5, select an axis to be a manual manipulation target by touching the touch-type pointing device 22 with any of the thumb, the forefinger, the middle finger, the third finger and the little finger or combination thereof in a first manipulation and specify a movement direction and movement speed of the axis selected in the first manipulation by performing a second manipulation of performing dragging on the screen with the finger that has touched the touch-type pointing device 22 in the first manipulation as shown in FIG. 11. When such a manipulation method is adopted, it becomes possible to specify the axis to be a manual manipulation target among five axes in the first manipulation. In a case where the touch-type pointing device 22 is touched with a plurality of fingers in the first manipulation, an intermediate position (an average position) among a plurality of touch points by the first manipulation can be treated as a touch position of the first manipulation, and an intermediate position (an average position) among a plurality of touch points after the second manipulation (after the drag) can be treated as a touch position after the second manipulation (after the drag).

Description has been made on an embodiment of the present invention. The present invention, however, is not limited to the example of the embodiment described above but can be embodied in other aspects by making appropriate changes.

1. A numerical controller controlling a machine, comprising:
a touch-type pointing device capable of detecting a touch manipulation;
a manipulation analyzing portion analyzing and extracting a first manipulation which is a touch manipulation by at least one touch and a second manipulation which is a manipulation performed while a touch state by the first manipulation is maintained, from among manipulations detected by the touch-type pointing device; and
an operation deciding portion deciding a function of the machine or a function of the numerical controller to be caused to operate, based on the first manipulation and the second manipulation and giving an instruction to cause the function to operate.

2. The numerical controller according to claim 1, wherein
the machine is provided with one or more axes; and
the operation deciding portion decides an axis to be a manual manipulation target among the axes based on the first manipulation, calculates a movement direction and movement speed of the axis to be the manual manipulation target, based on the second manipulation; and gives an instruction to control the decided axis to be the manual manipulation target with the calculated movement direction and movement speed.

3. The numerical controller according to claim 2, wherein the operation deciding portion decides the axis to be the manual manipulation target among the axes, based on the number of touch points by the first manipulation.

4. The numerical controller according to claim 2, wherein
the second manipulation is a touch manipulation; and
the operation deciding portion calculates the movement direction and movement speed of the axis to be the manual manipulation target, based on a position of touch points by the first manipulation and a position of touch points by the second manipulation.

5. The numerical controller according to claim 2 or 3, wherein
the second manipulation is a drag manipulation; and
the operation deciding portion calculates the movement direction and movement speed of the axis to be the manual manipulation target, based on a position of touch points by the first manipulation and a position of touch points by the second manipulation after a drag.

6. The numerical controller according to claim 1, wherein
the numerical controller is capable of switching between an operation mode in which a multi-touch gesture manipulation is accepted and an operation mode in which the multi-touch gesture manipulation is not accepted; and
the manipulation analyzing portion analyzes and extracts the first manipulation and the second manipulation among the manipulations detected by the touch-type pointing device only in the operation mode in which the multi-touch gesture manipulation is accepted.
